(19) United States
(12) Patent Application Publication
(10) Pub. No.: US 2020/0383055 A1
(43) Pub. Date: Dec. 3, 2020

(54) SIGNAL PROCESSING METHOD AND APPARATUS

(71) Applicant: HUAWEI TECHNOLOGIES CO., LTD., Shenzhen (CN)

(72) Inventors: Yu CAI, Beijing (CN); Yongbo ZENG, Beijing (CN); Jian WANG, Beijing (CN)

(73) Assignee: HUAWEI TECHNOLOGIES CO., LTD., Shenzhen (CN)

(21) Appl. No.: 16/496,467

(22) PCT Filed: Mar. 24, 2017
(86) PCT No.: PCT/CN2017/078187

§ 371 Date: Sep. 23, 2019

(51) Int. Cl. H04W 52/02; H04W 72/04; H04W 56/00; H04W 8/00

(52) U.S. Cl. CPC H04W 52/0229; H04W 72/048; H04W 88/04; H04W 8/005; H04W 56/001

(57) ABSTRACT

An exemplary embodiment provides a signal processing method and apparatus. A first user equipment determines, based on a first message, a first resource used by second user equipment to send a second message, and detects and/or receives the second message on the first resource, so as to avoid excessively high power consumption caused when the first user equipment detects and/or receives the second message on many resources, thereby reducing power consumption of the first user equipment.

This application is a national stage of International Application No. PCT/CN2017/078187, filed on Mar. 24, 2017, which is hereby incorporated by reference in its entirety.

### FIELD

Embodiments relate to wireless communications technologies, and in particular, to a signal processing method and apparatus.

### BACKGROUND

Device-to-device (D2D) communication based on a cellular network, or referred to as a proximity service (ProSe), is a new technology in which devices are allowed to perform direct communication by multiplexing a cell resource under control of a system. In the D2D communication, spectrum efficiency in a cellular communications system can be improved, so that a problematic lack of spectrum resources in a wireless communications system is resolved to some extent.

The D2D communication includes a relay operation from user equipment to a network. In other words, remote user equipment can be connected to the network by using relay user equipment. The remote user equipment can discover the relay user equipment by using a sidelink discovery message. The remote user equipment may further establish a connection to the relay user equipment. However, in a discovery process and a connection establishment process, power consumption of the remote user equipment is relatively high.

### SUMMARY

Embodiments provide a signal processing method and apparatus, to reduce power consumption of remote user equipment.

A first embodiment provides a signal processing method. In the method, first user equipment receives a first message, and determines, based on the first message, a first resource used by second user equipment to send a second message, and then the first user equipment processes the second message via the first resource, where the processing includes at least one of detection and/or receiving. In the signal processing method, the first user equipment determines, based on the first message, the first resource used by the second user equipment to send the second message, and detects and/or receives the second message on the first resource, so as to avoid excessively high power consumption caused when the first user equipment detects and/or receives the second message on many resources, thereby reducing power consumption of the first user equipment.

In an exemplary embodiment, the step where the first user equipment determines, based on the first message, a first resource used by second user equipment to send a second message may include: determining, by the first user equipment based on a second resource used for the first message, the first resource used by the second user equipment to send the second message.

In an exemplary embodiment, the first message includes indication information, and the indication information is used to determine the first resource used by the second user equipment to send the second message. In this case, the step where the first user equipment determines, based on the first message, a first resource used by second user equipment to send a second message may include: determining, by the first user equipment, the first resource based on the indication information.

In an exemplary embodiment, the determining, by the first user equipment based on a second resource used for the first message, the first resource used by the second user equipment to send the second message may include: determining, by the first user equipment based on a third message sent by the first user equipment and the second resource used for the first message, the first resource used by the second user equipment to send the second message.

In an exemplary embodiment, the third message may include an identifier of the first user equipment. The determining, by the first user equipment based on a third message sent by the first user equipment and the second resource used for the first message, the first resource used by the second user equipment to send the second message may include: determining, by the first user equipment based on the identifier of the first user equipment and the second resource used for the first message, the first resource used by the second user equipment to send the second message.

In an exemplary embodiment, the determining, by the first user equipment based on a third message sent by the first user equipment and the second resource used for the first message, the first resource used by the second user equipment to send the second message may include: determining, by the first user equipment based on the second resource used for the first message and a third resource used by the first user equipment to send the third message, the first resource used by the second user equipment to send the second message.

In an exemplary embodiment, the determining, by the first user equipment, the first resource based on the indication information may include: determining, by the first user equipment based on a third message sent by the first user equipment and the indication information, the first resource used by the second user equipment to send the second message.

In an exemplary embodiment, the third message may include an identifier of the first user equipment. The determining, by the first user equipment based on a third message sent by the first user equipment and the indication information, the first resource used by the second user equipment to send the second message may include: determining, by the first user equipment based on the identifier of the first user equipment and the indication information, the first resource used by the second user equipment to send the second message.

In an exemplary embodiment, the determining, by the first user equipment based on a third message sent by the first user equipment and the indication information, the first resource used by the second user equipment to send the second message may include: determining, by the first user equipment based on the indication information and a third resource that is used by the first user equipment to send the third message, the first resource used by the second user equipment to send the second message.

In an exemplary embodiment, the first message may include indication information, and the indication information is used to determine the first resource used by the second user equipment to send the second message. In this implementation, the step where the first user equipment determines, based on the first message, a first resource used by second user equipment to send a second message may include: determining, by the first user equipment, the first resource based on an identifier of the second user equipment and the indication information.

In an exemplary embodiment, the step where the first user equipment determines, based on the first message, a first resource used by second user equipment to send a second message may include: determining, by the first user equipment, an identifier of the second user equipment based on the first message; and determining, based on the identifier of the second user equipment, the first resource used by the second user equipment to send the second message. The first user equipment receives the first message sent by the second user equipment, and the first message may include the identifier of the second user equipment. The first user equipment determines, based on the identifier of the second user equipment, the first resource used by the second user equipment to send the second message.

In an exemplary embodiment, the step where the first user equipment determines, based on the first message, a first resource used by second user equipment to send a second message may include: determining, by the first user equipment based on the first message and a user equipment (the first user equipment and/or the second user equipment) identifier, the first resource used by the second user equipment to send the second message.

In an exemplary embodiment, an identifier of the second user equipment may be determined by the first user equipment based on the first message or a fourth message sent by the second user equipment.

In an exemplary embodiment, an identifier of the first user equipment may be determined by the second user equipment based on a fifth message. The fifth message is sent by the first user equipment to the second user equipment. Further, the second user equipment determines, based on the identifier of the first user equipment, the first resource used by the second user equipment to send the second message.

In an exemplary embodiment, the step where the first user equipment determines, based on the first message, a first resource used by second user equipment to send a second message may include: determining, by the first user equipment based on the user equipment identifier and the second resource used for the first message, the first resource used by the second user equipment to send the second message. For example, the first resource may be a subband. The first user equipment determines, based on a subband used for the first message, that there may be M subbands used by the second user equipment to send the second message, where M is an integer greater than or equal to 1. The first user equipment determines, based on the user equipment identifier, that a subband used by the second user equipment to send the second message is one of the M subbands.

In an exemplary embodiment, the step where the first user equipment determines, based on the first message, a first resource used by second user equipment to send a second message may include: determining, by the first user equipment based on indication information included in the first message and the user equipment identifier, the first resource used by the second user equipment to send the second message. For example, the first resource may be a subband. The first user equipment determines, based on the indication information, that there may be M subbands used for the second message, where M is an integer greater than or equal to 1. The first user equipment determines, based on the user equipment identifier, that a subband used by the second user equipment to send the second message is one of the M subbands.

In an exemplary embodiment, after the first user equipment receives the first message, the signal processing method may further include: sending, by the first user equipment, a sidelink message to the second user equipment.

A second exemplary embodiment provides a signal processing apparatus, and the signal processing apparatus is first user equipment. The signal processing apparatus includes a receiving module, a determining module, and a processing module. The receiving module is configured to receive a first message. The determining module is configured to determine, based on the first message, a first resource used by second user equipment to send a second message. The processing module is configured to process the second message by using the first resource. The processing includes at least one of detection and receiving. In the signal processing apparatus, the first user equipment determines, based on the first message, the first resource used by the second user equipment to send the second message, and detects and/or receives the second message on the first resource, so as to avoid excessively high power consumption caused when the first user equipment detects and/or receives the second message on many resources, thereby reducing power consumption of the first user equipment.

In an exemplary embodiment, the determining module may be configured to determine, based on a second resource used for the first message, the first resource used by the second user equipment to send the second message.

In an exemplary embodiment, the first message may include indication information, and the indication information is used to determine the first resource used by the second user equipment to send the second message. In this case, the determining module may be configured to determine the first resource based on the indication information.

In an exemplary embodiment, when determining, based on the second resource used for the first message, the first resource used by the second user equipment to send the second message, the determining module may be configured to determine, based on a third message sent by the first user equipment and the second resource used for the first message, the first resource used by the second user equipment to send the second message.

In an exemplary embodiment, when determining the first resource based on the indication information, the determining module may be configured to determine, based on a third message sent by the first user equipment and the indication information, the first resource used by the second user equipment to send the second message.

In an exemplary embodiment, the signal processing apparatus may further include a sending module, configured to send a sidelink message to the second user equipment after the receiving module receives the first message.

In an exemplary embodiment, the third message may be a sidelink message and/or a sidelink control information (SCI) corresponding to the sidelink message. The sidelink message may be a sidelink discovery message or a sidelink communication message.

In an exemplary embodiment, the second resource may be a subband, a physical resource block (PRB), a subframe, and/or a resource pool. The first resource corresponds to the second resource and is a subband, a PRB, a subframe, and/or a resource pool.

In an exemplary embodiment, the first message may be a sidelink discovery message or first synchronization information. The first synchronization information may be a synchronization signal and/or a master information block-sidelink (MIB-SL).

In an exemplary embodiment, the second message may be any one or more of second synchronization information, a sidelink message, and an SCI corresponding to the sidelink message. The second synchronization information may be a synchronization signal and/or an MIB-SL. The sidelink message may be a sidelink discovery message or a sidelink communication message.

In an exemplary embodiment, the first message may be sent by the second user equipment or third user equipment.

A third exemplary embodiment provides user equipment, and the user equipment has functions of implementing the first user equipment in the foregoing method. These functions may be implemented by using hardware, or may be implemented by hardware by executing corresponding software. The hardware or software includes one or more modules corresponding to the foregoing functions.

A fourth exemplary embodiment provides user equipment, and the user equipment includes a memory and a processor. The memory is configured to store a program instruction, and the processor is configured to invoke the program instruction in the memory to implement the method in the first aspect and the implementations of the first aspect.

A fifth exemplary embodiment provides a program. When being executed by a processor, the program is used to perform the method in the first exemplary embodiment.

A sixth exemplary embodiment provides a program product, including the program in the third exemplary embodiment.

A seventh exemplary embodiment provides a computer readable storage medium. The computer readable storage medium stores an instruction. When the instruction runs on a computer, the computer is enabled to perform the method in the first aspect.

### DESCRIPTION OF DRAWINGS

FIG. 1 shows a network architecture;

FIG. 2 is a schematic flowchart of an exemplary embodiment of a signal processing method;

FIG. 3 is an example diagram of a resource location in a signal processing method;

FIG. 4 is an example diagram of another resource location in a signal processing method;

FIG. 5 is an example diagram of still another resource location in a signal processing method;

FIG. 6 is a schematic structural diagram of an exemplary embodiment of a signal processing apparatus;

FIG. 7 is a schematic structural diagram of an exemplary embodiment of a signal processing apparatus; and

FIG. 8 is a schematic structural diagram of an exemplary embodiment of a signal processing apparatus.

### DESCRIPTION OF EMBODIMENTS

It should be understood that the term “and/or” in this specification describes only an association relationship for describing associated objects and represents that three relationships may exist. For example, “a first element and/or a second element” may represent the following three cases: Only the first element exists, both the first and the second elements exist, and only the second element exists.

In the prior art, remote user equipment and relay user equipment establish a connection by using the following processes:

(1) A process in which the remote user equipment discovers the relay user equipment. The discovery process includes two models:

In a first model, the relay user equipment sends a user equipment-to-network relay discovery announcement message. The remote user equipment receives the user equipment-to-network relay discovery announcement message, to discover the relay user equipment.

In a second model, the remote user equipment sends a user equipment-to-network relay discovery solicitation message. The relay user equipment receives the user equipment-to-network relay discovery solicitation message, to discover the remote user equipment. Then, the relay user equipment sends a user equipment-to-network relay discovery response message. The remote user equipment receives the user equipment-to-network relay discovery response message, to discover the relay user equipment.

(2) A process in which the remote user equipment and the relay user equipment establish a direct link.

The remote user equipment sends a direct communication request message. The relay user equipment receives the direct communication request message and returns a direct connection request accept message or a direct connection request reject message to the remote user equipment. A sidelink communication message may include but is not limited to a direct communication request message, a direct connection request accept message, and a direct connection request reject message.

The remote user equipment needs to detect or receive, on all allocated resources, a message sent by the relay user equipment, to ensure that the remote user equipment receives, in a timely manner, the message sent by the relay user equipment. However, detecting or receiving, on all the allocated resources, the message sent by the relay user equipment causes relatively high power consumption of the remote user equipment. The remote user equipment is a device with a limited battery capability, for example, a battery capacity of the remote user equipment is relatively small, or a charging interval of the remote user equipment is relatively long. Therefore, the remote user equipment is usually required to consume less power.

Based on the foregoing problem, a signal processing method is provided to avoid excessively high power consumption caused when a first user equipment, such as a remote user equipment, detects and/or receives, on many resources, a second message sent by a second user equipment, such as a relay user equipment, thereby reducing power consumption of the first user equipment.

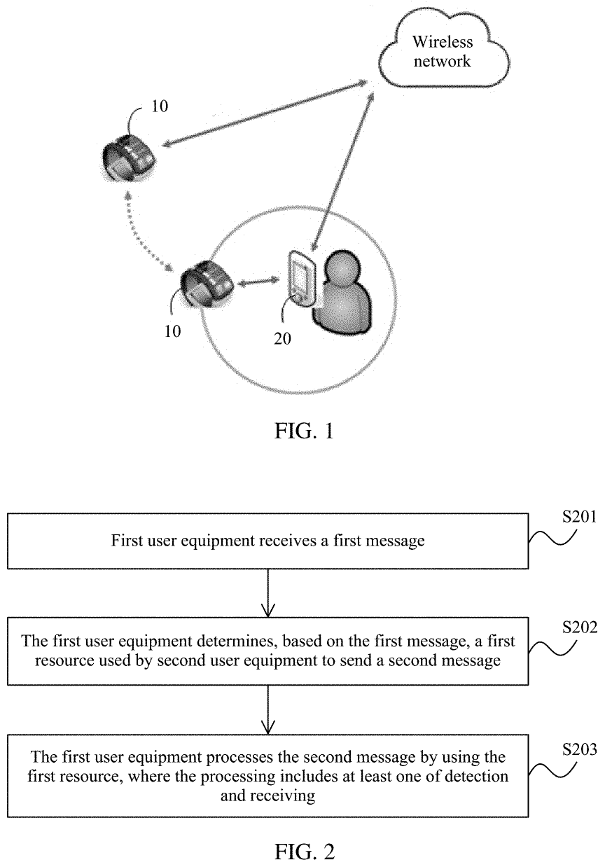

The following describes an exemplary system architecture with reference to FIG. 1. FIG. 1 shows a network architecture. As shown in FIG. 1, the system architecture provided in the embodiments includes at least one first user equipment 10 and at least one second user equipment 20.

The second user equipment 20 is user equipment that provides a network access service, and may allow the first user equipment 10 to access a wireless network by using the second user equipment 20. Alternatively, the first user equipment 10 may directly access a wireless network.

The first user equipment 10 may be a wearable device, such as a smartwatch, a smart band, or smart glasses. Alternatively, the first user equipment 10 may be a machine-type communication (MTC) device or an Internet of Things (IoT) device, such as a smart electricity meter or a smart water meter.

The second user equipment 20 may be a wireless terminal. The wireless terminal may refer to a device that provides a user with voice and/or another service data connectivity, a handheld device with a wireless connection function, or another processing device connected to a wireless modem. The wireless terminal may communicate with one or more core networks through a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the RAN. For example, the wireless terminal may be a device such as a personal communications service (PCS) phone, a cordless telephone set, a session initiation protocol (SIP) phone, a wireless local loop (WLL) station, or a personal digital assistant (PDA).

FIG. 1 shows an example in which the first user equipment 10 is a smart band and the second user equipment 20 is a mobile phone.

The following describes in detail the signal processing method by using a detailed embodiment.

FIG. 2 is a schematic flowchart of an exemplary embodiment of a signal processing method. The method may be performed by a signal processing apparatus. The apparatus may be the first user equipment, and for example, may be a smart band, as shown in FIG. 1. Alternatively, the apparatus may be integrated into the first user equipment. As shown in FIG. 2, the method includes the following steps.

In step 201, the first user equipment receives a first message.

The first message may be a sidelink discovery message, first synchronization information, or the like. The first synchronization information may be a synchronization signal and/or a MIB-SL, however, this embodiment is not limited thereto. The sidelink discovery message may be a user equipment-to-network relay discovery announcement message or a user equipment-to-network relay discovery response message.

Referring to the prior art, in a process in which remote user equipment discovers relay user equipment, the remote user equipment is the first user equipment, the relay user equipment is second user equipment, and the remote user equipment receives a sidelink discovery message sent by the relay user equipment. In this case, the first message is the sidelink discovery message. Alternatively, before the remote user equipment receives a sidelink message sent by the relay user equipment, the remote user equipment receives first synchronization information sent by the relay user equipment or another user equipment, so as to obtain information such as a timing. In this case, the first message is the first synchronization information. The sidelink message may be a sidelink discovery message or a sidelink communication message. The “another user equipment” may be understood by a person of ordinary skill in the art as a third user equipment. In other words, the first message is sent by the third user equipment to the first user equipment.

It should be noted that first synchronization information received by the remote user equipment before the remote user equipment receives a sidelink discovery message sent by the relay user equipment is the same as or different from first synchronization information received by the remote user equipment before the remote user equipment receives a sidelink communication message sent by the relay user equipment. This is not limited in this embodiment.

In step 202, the first user equipment determines, based on the first message, a first resource used by the second user equipment to send a second message.

In this step, still referring to the prior art, in the process in which the remote user equipment discovers the relay user equipment, the remote user equipment determines, based on the sidelink discovery message, the first resource used by the second user equipment to send the second message. Alternatively, the remote user equipment determines, based on the first synchronization information, the first resource used by the second user equipment to send the second message.

The second message may be any one or more of second synchronization information, a sidelink message, and an SCI corresponding to the sidelink message. The second synchronization information may be a synchronization signal and/or an MIB-SL. The sidelink message may be a sidelink discovery message or a sidelink communication message.

When the first message is the sidelink discovery message, the second message is any one or more of synchronization information, the sidelink communication message, and/or the SCI corresponding to the sidelink communication message. When the first message is the first synchronization information, the second message is any one or more of the sidelink discovery message, the SCI corresponding to the sidelink discovery message, the sidelink communication message, and the SCI corresponding to the sidelink communication message. Alternatively, when the first message is the first synchronization information, the second message is the second synchronization information.

For example, after receiving the sidelink discovery message, the remote user equipment initiates a direct communication request message, and receives a response of the relay user equipment for the direct communication request message. The remote user equipment may determine, based on the received sidelink discovery message, a resource used for a sidelink communication message or corresponding SCI sent by the relay user equipment. When sending the sidelink communication message or the corresponding SCI, the relay user equipment may send synchronization information on a same subband. The remote user equipment may determine, based on the received sidelink discovery message, the first resource used for second synchronization information detected and/or received by the remote user equipment when the remote user equipment receives the sidelink communication message sent by the relay user equipment. Before receiving each of the sidelink discovery message and the sidelink communication message, the remote user equipment needs to obtain synchronization information. The remote user equipment may determine, based on first synchronization information, a resource for the sidelink discovery message sent by the relay user equipment. The remote user equipment may determine, based on the first synchronization information, the resource used for the sidelink communication message or the corresponding SCI sent by the relay user equipment. In addition, the remote user equipment may determine, based on the first synchronization information received when the remote user equipment receives the sidelink discovery message sent by the relay user equipment, the first resource used for the second synchronization information detected and/or received by the remote user equipment when the remote user equipment receives the sidelink communication message sent by the relay user equipment. In addition, when receiving messages on different subbands, the remote user equipment may need to receive synchronization information on the different subbands. Therefore, the first resource used for a subsequently received second synchronization message may be determined based on a second resource used for received first synchronization information corresponding to a received message.

The first resource may include a frequency domain resource and/or a time domain resource, or a resource pool. The frequency domain resource may be a PRB or a subband. The time domain resource may be a subframe. The resource pool may include a group of time-frequency resources.

In step 203, the first user equipment processes the second message by using the first resource, where the processing includes at least one of detection and receiving.

The first user equipment detects and/or receives the second message on the first resource.

It should be noted that the terms “first”, “second”, and the like in the embodiments are intended to distinguish between similar objects, and are not necessarily intended to describe a specific sequence or sequences.

In this embodiment, the first user equipment determines, based on the first message, the first resource used by the second user equipment to send the second message, and detects and/or receives the second message on the first resource, so as to avoid excessively high power consumption caused when the first user equipment detects and/or receives the second message on many resources, thereby reducing power consumption of the first user equipment.

In addition, some remote user equipment supports relatively narrow bandwidth, resulting in a longer time consumed by the remote user equipment to detect or receive a message sent by the relay user equipment. If the signal processing method provided is used, because the first user equipment detects and/or receives the second message on the determined first resource, a time consumed by the first user equipment such as the remote user equipment to detect or receive a message sent by the second user equipment such as the relay user equipment can be further shortened.

In addition, because some remote user equipment supports relatively narrow bandwidth, when the relay user equipment sends the second message on a frequency resource in a subframe, but the remote user equipment performs detection on another frequency resource, the remote user equipment may not receive the second message sent by the relay user equipment, resulting in an information loss. If the signal processing method provided is used, because the first user equipment detects and/or receives the second message on the determined first resource, the information loss can be further avoided.

In the foregoing embodiment, the first user equipment may determine, based on the first message in a number of implementations, the first resource used by the second user equipment to send the second message. The following provides description by using examples.

In an implementation, the step where the first user equipment determines, based on the first message, a first resource used by the second user equipment to send a second message may include: determining, by the first user equipment based on a second resource used for the first message, the first resource used by the second user equipment to send the second message.

The second resource may be any one or more of a subband, a PRB, a subframe, and a resource pool, and the first resource corresponds to the second resource and is one or more of a subband, a PRB, a subframe, and a resource pool. In other words, the first resource and the second resource may have a same type or different types.

A base station may configure one or more resources used for a sidelink communication message and a resource used for one sidelink discovery message that are in a correspondence. For example, when resource allocation of the relay user equipment is performed in a mode of scheduling by the base station, the base station schedules a resource used by the relay user equipment for sending a sidelink communication message and a resource for sending a sidelink discovery message that are in a correspondence. When resource allocation of the relay user equipment is performed in a mode of autonomous selection, the relay user equipment selects a resource for sending a sidelink communication message and a resource for sending a sidelink discovery message that are in a correspondence.

That a resource is a subband is used as an example. The relay user equipment may send synchronization information on a subband on which a sidelink message is sent. The remote user equipment may determine, based on the subband on which the received synchronization information is located, to receive the sidelink message on the subband, or receive, on the subband, SCI corresponding to the sidelink message. The sidelink message may be a sidelink discovery message or a sidelink communication message.

Alternatively, a subband on which the relay user equipment sends a sidelink message or corresponding SCI is configured by the base station. The remote user equipment may determine the configured subband based on synchronization information, and detect and/or receive, on the subband, the sidelink message or the corresponding SCI sent by the relay user equipment. The synchronization information may be sent by the relay user equipment or another user equipment.

The relay user equipment may further send a sidelink communication message or corresponding SCI on a subband on which a sidelink discovery message is sent. The remote user equipment may determine, based on the subband for the sidelink discovery message, to receive the sidelink communication message or the corresponding SCI on the subband.

The following separately provides detailed description by using examples in which both the second resource and the first resource are subbands, PRBs, or subframes.

1. Both the second resource and the first resource are subbands. The first user equipment determines, based on a subband used for the first message, a subband used by the second user equipment to send the second message. For example, the first user equipment determines, based on a subband used for a sidelink discovery message, a subband used by the second user equipment to send a sidelink communication message or corresponding SCI.

In a case, there is one or more offsets between the subband used for the first message and the subband used for the second message, and the offset may be 0 or any other integer value. The offset may be specified in a standard protocol, may be preconfigured, or may be configured by the base station. The first user equipment determines, based on the subband used for the first message and the offset, the subband used by the second user equipment to send the second message.

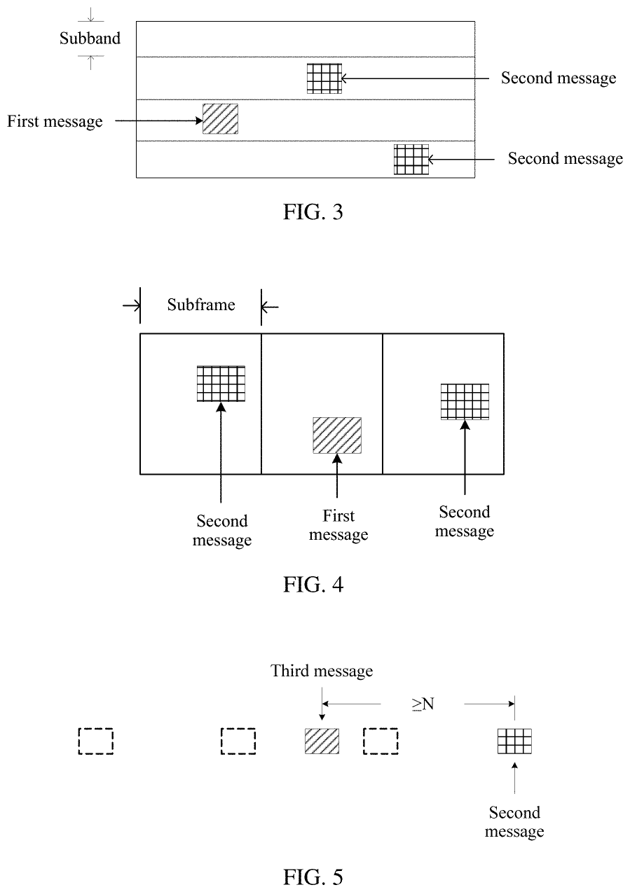

For example, if the offset is 1, it indicates that a subband index used for the second message is a subband index used for the first message plus 1 and/or minus 1. Referring to FIG. 3, a vertical direction represents different subbands, and each rectangle represents one subband. The subband used for the first message is shown as a box filled with slashes, and the subband used for the second message is shown as a box filled with grids. The subband used for the second message may be located above the subband used for the first message, and/or the subband used for the second message may be located below the subband used for the first message.

In another exemplary case, there is a mapping relationship between a subband used for the first message and a subband used for the second message. The mapping relationship may be one-to-one mapping, one-to-many mapping, or many-to-one mapping. The mapping relationship may be specified in a standard protocol, may be preconfigured, or may be configured by the base station. The first user equipment determines, based on the subband used for the first message and the mapping relationship, the subband used by the second user equipment to send the second message.

For example, there are a total of N subband indexes, where N is an integer. When a subband index used for the first message is 1, a subband index used for the second message is N-1. When a subband index used for the first message is 2, a subband index used for the second message is N-2, and so on.

2. Both the second resource and the first resource are PRBs. The first user equipment determines, based on a PRB used for the first message, a PRB used by the second user equipment to send the second message. For example, the first user equipment determines, based on a PRB used for a sidelink discovery message, a PRB used by the second user equipment to send a sidelink communication message or a corresponding SCI.

Referring to the embodiment in which both the second resource and the first resource are the subbands, only the subband needs to be replaced with the PRB. Details are not described herein.

3. Both the second resource and the first resource are subframes. The first user equipment determines, based on a subframe used for the first message, a subframe used by the second user equipment to send the second message. For example, the first user equipment determines, based on a subframe used for a sidelink discovery message, a subframe used by the second user equipment to send a sidelink communication message or a corresponding SCI.

Referring to the embodiment in which both the second resource and the first resource are the subbands, only the subband needs to be replaced with the subframe. Details are not described herein.

For example, if an offset is 1, it indicates that a subframe number used for the second message is a subframe number used for the first message plus 1 and/or minus 1. Referring to FIG. 4, a vertical direction represents different subframes, and each rectangle represents one subframe. The subframe used for the first message is shown as a box filled with slashes, and the subframe used for the second message is shown as a box filled with grids. The subframe used for the second message may be located on a left side of the subframe used for the first message, and/or the subframe used for the second message may be located on a right side of the subframe used for the first message.

When the first resource and the second resource have different types, the following example may describe an exemplary embodiment.

For example, the first user equipment may determine, based on a PRB used for the first message, a subband used by the second user equipment to send the second message. Alternatively, the first user equipment may determine, based on a PRB used for the first message on a subband, a subband used by the second user equipment to send the second message. For example, one subband includes six PRBs. When the first PRB and the second PRB on the subband are used for the first message, it is determined that a subband used for the second message is a subband 1. When the third PRB and the fourth PRB on the subband are used for the first message, it is determined that a subband used for the second message is a subband 2. Alternatively, the first user equipment may determine, based on a subband used for the first message, a resource pool used by the second user equipment to send the second message. For example, when the first message is on the subband 1, it is determined that a resource pool used for the second message is a resource pool 1. When the first message is on the subband 2, it is determined that a resource pool used for the second message is a resource pool 2.

Based on this implementation, the determining, by the first user equipment based on a second resource used for the first message, the first resource used by the second user equipment to send the second message may include: determining, by the first user equipment based on a third message sent by the first user equipment and the second resource used for the first message, the first resource used by the second user equipment to send the second message. The third message may be a sidelink message and/or an SCI corresponding to the sidelink message. The sidelink message may be a sidelink discovery message or a sidelink communication message. When the third message is a sidelink discovery message sent by the first user equipment, the sidelink discovery message may be a user equipment-to-network relay discovery solicitation message.

In a possible implementation, the third message may include an identifier of the first user equipment. The first user equipment determines, based on the identifier of the first user equipment and the second resource used for the first message, the first resource used by the second user equipment to send the second message. That both the first resource and the second resource are subbands is used as an example. The first user equipment determines, based on a subband used for the first message, that there may be N subbands used for the second message. The first user equipment determines, based on the identifier of the first user equipment, that a subband used by the second user equipment to send the second message is one of the N subbands. For example, if the N subbands that may be used for the second message are a subband 0, a subband 1, a subband 2, and a subband 3, that is, N is 4, and the identifier of the first user equipment is represented as ID, an index of the subband used for the second message is ID mod 4, where mod represents a modulo operation. For example, when a value of the ID is 0 or an integer multiple of 4, the index of the subband used for the second message is 0. If a value of the ID is 1 or 5, the index of the subband used for the second message is 1.

It should be noted that a user equipment identifier (including the identifier of the first user equipment and an identifier of the second user equipment) may be a layer-2 identifier (layer-2 ID), or may be another identifier. This is not limited in this embodiment.

In another possible implementation, the first user equipment determines, based on the second resource used for the first message and a third resource used by the first user equipment to send the third message, the first resource used by the second user equipment to send the second message.

For example, the first user equipment determines that a number of the first resource used by the second user equipment to send the second message is m+offset+P×i. P represents a period, m represents a number of the second resource used for the first message, “offset” is an offset, and i is an integer greater than or equal to 0. The formula indicates that the first user equipment determines that the first resource used by the second user equipment to send the second message may be a resource with an offset of “offset” resource numbers before and/or after the second resource m used for the first message, and is one of multiple resources repeated in the period P. If a number of the resource used by the first user equipment to send the third message is n, the first user equipment determines, based on n, that the resource used for the second message is one of the multiple resources. For example, the resource used for the second message is the first resource whose resource number is greater than or equal to n+N in the multiple resources, where N is a positive integer. As shown in FIG. 5, a horizontal direction represents different subframes, dashed-line boxes represent a number of subframes that may be used for the second message, a subframe used for the third message is shown as a box filled with slashes, and a subframe used for the second message is shown as a box filled with grids.

In another implementation, the first message may include indication information, and the indication information is used to determine the first resource used by the second user equipment to send the second message. In this implementation, the step where the first user equipment determines, based on the first message, a first resource used by the second user equipment to send a second message may include: determining, by the first user equipment, the first resource based on the indication information.

The indication information may include the offset in the foregoing embodiment, or the indication information may include an absolute location of the first resource. For example, the indication information includes an offset corresponding to a subband, an offset corresponding to a subframe, an offset corresponding to a PRB, or an offset corresponding to a resource pool.

Similar to the foregoing embodiment, the first resource determined based on the indication information may include a number of subbands, subframes, PRBs, or resource pools. Therefore, the determining, by the first user equipment, the first resource based on the indication information may include: determining, by the first user equipment based on a third message sent by the first user equipment and the indication information, the first resource used by the second user equipment to send the second message. In other words, in a number of first resources determined based on the indication information, a first resource is further determined based on the third message sent by the first user equipment. The third message may be a sidelink message and/or an SCI corresponding to the sidelink message, and the sidelink message is a sidelink discovery message or a sidelink communication message.

The third message may include an identifier of the first user equipment. The first user equipment determines, based on the identifier of the first user equipment and the indication information, the first resource used by the second user equipment to send the second message. For example, the first user equipment determines, based on the indication information, a resource pool for sending the second message. The first user equipment determines, based on the identifier of the first user equipment, the first resource used by the second user equipment to send the second message in the determined resource pool.

Alternatively, the first user equipment determines, based on the indication information and a third resource that is used by the first user equipment to send the third message, the first resource used by the second user equipment to send the second message. For example, the first user equipment determines, based on the indication information, a resource pool for sending the second message. The first user equipment determines, based on the third resource used by the first user equipment to send the third message, the first resource used by the second user equipment to send the second message in the determined resource pool.

When the first message is a sidelink discovery message, the indication information may be included in a media access control protocol data unit (MAC PDU) or a physical protocol data unit (PHY PDU) of the sidelink discovery message. When the first message is synchronization information, the indication information may be included in a MIB-SL, or the indication information is a sidelink synchronization signal identifier (sidelink synchronization signal ID, SLSSID) used by a synchronization signal, a scrambling code sequence used by a synchronization signal, or the like.

Based on the foregoing embodiments, after the first user equipment receives the first message and before the first user equipment receives the second message sent by the second user equipment, the signal processing method may further include: sending, by the first user equipment, a sidelink message to the second user equipment. Herein, the sidelink message may be the foregoing third message.

The first message may include indication information, and the indication information is used to determine the first resource used by the second user equipment to send the second message. In this exemplary implementation, the step where the first user equipment determines, based on the first message, a first resource used by the second user equipment to send a second message may include: determining, by the first user equipment, the first resource based on an identifier of the second user equipment and the indication information.

In still another implementation, the step where the first user equipment determines, based on the first message, a first resource used by the second user equipment to send a second message may include: determining, by the first user equipment, an identifier of the second user equipment based on the first message; and determining, based on the identifier of the second user equipment, the first resource used by the second user equipment to send the second message. The first user equipment receives the first message sent by the second user equipment, and the first message may include the identifier of the second user equipment. The first user equipment determines, based on the identifier of the second user equipment, the first resource used by the second user equipment to send the second message. That the first resource is a subband is used as an example. Subbands that may be used for the second message are four subbands in total: a subband 0, a subband 1, a subband 2, and a subband 3. If the identifier of the second user equipment is represented as ID, an index of a determined subband used for the second message is ID mod 4, where mod represents a modulo operation.

In yet another implementation, the step where the first user equipment determines, based on the first message, a first resource used by the second user equipment to send a second message may include: determining, by the first user equipment based on the first message and a user equipment (the first user equipment and/or the second user equipment) identifier, the first resource used by the second user equipment to send the second message.

Optionally, an identifier of the second user equipment may be determined by the first user equipment based on the first message or a fourth message sent by the second user equipment.

Further, an identifier of the first user equipment may be determined by the second user equipment based on a fifth message. The fifth message is sent by the first user equipment to the second user equipment. Further, the second user equipment determines, based on the identifier of the first user equipment, the first resource used by the second user equipment to send the second message.

The first user equipment determines, based on the user equipment identifier and the second resource used for the first message, the first resource used by the second user equipment to send the second message. For example, that the first resource is a subband is used as an example. The first user equipment determines, based on a subband used for the first message, that there may be M subbands used by the second user equipment to send the second message. The first user equipment determines, based on the user equipment identifier, that a subband used by the second user equipment to send the second message is one of the M subbands. For example, if the subbands that may be used for the second message are subband 0, subband 1, subband 2, and subband 3, that is, M is 4, and the identifier of the second user equipment is represented as ID, an index of the subband used for the second message is ID mod 4, where mod represents a modulo operation.

Alternatively, the first user equipment determines, based on indication information included in the first message and the user equipment identifier, the first resource used by the second user equipment to send the second message. For example, that the first resource is a subband is used as an example. The first user equipment determines, based on the indication information, that there may be M subbands used for the second message, where M is an integer greater than or equal to 1. The first user equipment determines, based on the user equipment identifier, that a subband used by the second user equipment to send the second message is one of the M subbands. For example, if the subbands that may be used for the second message are subband 0, subband 1, subband 2, and subband 3, that is, M is 4, and the identifier of the second user equipment is represented as ID, an index of the subband used for the second message is ID mod 4, where mod represents a modulo operation.

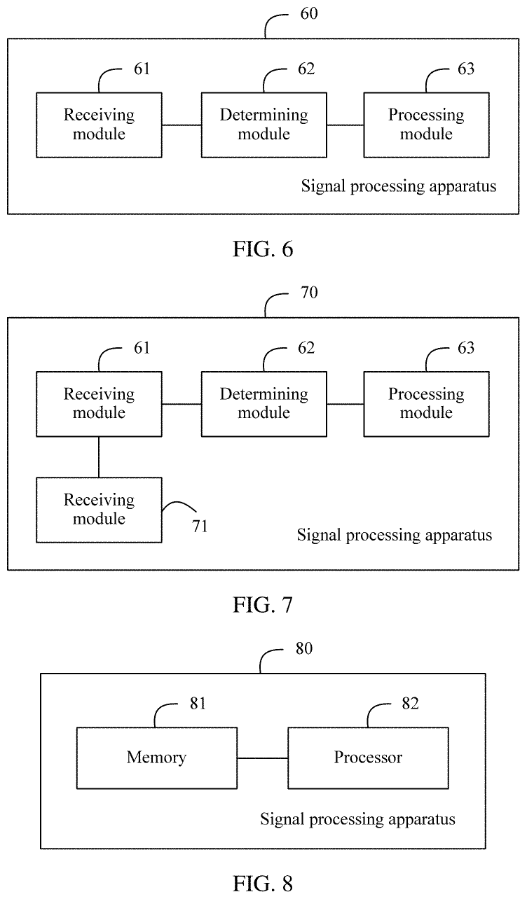

FIG. 6 is a schematic structural diagram of an embodiment 1 of a signal processing apparatus. The signal processing apparatus is a first user equipment. As shown in FIG. 6, the signal processing apparatus 60 in this embodiment includes a receiving module 61, a determining module 62, and a processing module 63. The determining module 62 is separately coupled to the receiving module 61 and the processing module 63.

The receiving module 61 is configured to receive a first message. The determining module 62 is configured to determine, based on the first message, a first resource used by second user equipment to send a second message. The processing module 63 is configured to process the second message by using the first resource. The processing includes at least one of detection and receiving.

The apparatus in this embodiment may be configured to perform the signal processing method provided in the foregoing embodiments. Exemplary implementation principles and technical effects are similar, and details are not described herein.

In another embodiment, the determining module 62 may be configured to determine, based on a second resource used for the first message, the first resource used by the second user equipment to send the second message.

In another embodiment, the first message may include indication information. The indication information may be used to determine the first resource used by the second user equipment to send the second message. The determining module 62 may be configured to determine the first resource based on the indication information.

Optionally, when determining, based on the second resource used for the first message, the first resource used by the second user equipment to send the second message, the determining module 62 may be configured to determine, based on a third message sent by the first user equipment and the second resource used for the first message, the first resource used by the second user equipment to send the second message.

Optionally, when determining the first resource based on the indication information, the determining module 62 may be configured to determine, based on a third message sent by the first user equipment and the indication information, the first resource used by the second user equipment to send the second message.

The third message may be a sidelink message and/or an SCI corresponding to the sidelink message. The sidelink message may be a sidelink discovery message or a sidelink communication message.

It should be noted that the second resource may be any one or more of a subband, a PRB, a subframe, and a resource pool. The first resource corresponds to the second resource and is one or more of a subband, a PRB, a subframe, and a resource pool. The first message may be a sidelink discovery message or first synchronization information. The first synchronization information may be a synchronization signal and/or an MIB-SL. The second message may be any one or more of second synchronization information, a sidelink message, and SCI corresponding to the sidelink message. The second synchronization information may be a synchronization signal and/or a MIB-SL. The sidelink message may be a sidelink discovery message or a sidelink communication message.

Optionally, the first message may be sent by the second user equipment or third user equipment.

Based on the structure shown in FIG. 6, and as shown in FIG. 7, a signal processing apparatus 70 may further include a sending module 71. The sending module 71 is configured to send a sidelink message to the second user equipment after the receiving module 61 receives the first message. The sending module 71 is coupled to the receiving module 61.

The apparatus in this embodiment may be configured to perform the signal processing method provided in the foregoing embodiments. Exemplary implementation principles and technical effects are similar, and details are not described herein.

In addition, it should be noted and understood that division of the modules of the foregoing signal processing apparatus is merely logical function division. There may be another division manner in actual implementation. For example, a number of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a number of network units. Some or all of the units may be selected based on actual requirements to achieve the objectives of the solutions of the embodiments.

In addition, functional units may be integrated into one processing unit, or each of the units may exist alone physically, or two or more units may be integrated into one unit. The integrated unit may be implemented in a form of hardware, or may be implemented in a form of hardware in addition to a software functional unit.

It should be further noted that, in the foregoing embodiments, the receiving module and the sending module may be implemented by using a transceiver. Alternatively, the receiving module is implemented by using an independent receiver, and the sending module is implemented by using an independent receiver. The determining module and the processing module in the foregoing embodiments may be implemented by using a processor with a data processing function.

FIG. 8 is a schematic structural diagram of an exemplary embodiment of a signal processing apparatus. Referring to FIG. 8, the signal processing apparatus 80 includes a memory 81 and a processor 82. The memory 81 is coupled to the processor 82.

The memory 81 is configured to store a program instruction, and the processor 82 is configured to invoke the program instruction in the memory 81 to implement the foregoing method embodiments.

The apparatus in this embodiment may be configured to perform the signal processing method provided in the foregoing embodiments. Exemplary implementation principles and technical effects are similar, and details are not described herein.

It should be understood that the processor may be a central processing unit (CPU), a general-purpose processor, a digital signal processor (DSP), an application-specific integrated circuit (ASIC), a field-programmable gate array (FPGA) or another programmable logic device, a transistor logic device, a hardware component, or a combination thereof. The processor may implement or execute various example logical blocks, modules, and circuits described with reference to content disclosed herein. Alternatively, the processor may be a combination of processors implementing a computing function, for example, a combination of one or more microprocessors, or a combination of a DSP and a microprocessor.

An exemplary embodiment further provides a program, and when being executed by a processor, the program is used to perform the signal processing method in the foregoing embodiments. An embodiment further provides a program product, for example, a computer readable storage medium, including the program described above. An embodiment further provides a computer readable storage medium. The computer readable storage medium stores an instruction, and when the instruction runs on the computer, the computer is enabled to perform the signal processing methods in the foregoing embodiments.

1. A signal processing method, comprising:
receiving, by first user equipment, a first message;
determining, by the first user equipment based on the first message, a first resource used by second user equipment to send a second message; and
processing, by the first user equipment, the second message by using the first resource, wherein the processing comprises at least one of detecting and receiving.

2. The method according to claim 1, wherein the determining, by the first user equipment based on the first message, of the first resource used by second user equipment to send a second message comprises:
determining, by the first user equipment based on a second resource used for the first message, the first resource used by the second user equipment to send the second message.

3. The method according to claim 1, wherein the first message comprises indication information, the indication information is used to determine the first resource used by the second user equipment to send the second message, and the determining, by the first user equipment based on the first message, of the first resource used by the second user equipment to send a second message comprises:
determining, by the first user equipment, the first resource based on the indication information.

4. The method according to claim 2, wherein the determining, by the first user equipment based on a second resource used for the first message, of the first resource used by the second user equipment to send the second message comprises:
determining, by the first user equipment based on a third message sent by the first user equipment and the second resource used for the first message, the first resource used by the second user equipment to send the second message.

5. The method according to claim 3, wherein the determining, by the first user equipment, the first resource based on the indication information comprises:
determining, by the first user equipment based on a third message sent by the first user equipment and the indication information, the first resource used by the second user equipment to send the second message.

6. The method according to claim 4, wherein the third message is a sidelink message and/or sidelink control information (SCI) corresponding to the sidelink message, and the sidelink message is a sidelink discovery message or a sidelink communication message.

7. The method according to claim 1, wherein the second resource is one or more of a subband, a physical resource block (PRB), a subframe, and a resource pool, and the first resource corresponds to the second resource and is one or more of a subband, a PRB, a subframe, and a resource pool.

8. The method according to claim 1, wherein the first message is a sidelink discovery message or first synchronization information, and the first synchronization information is a synchronization signal and/or a master information block-sidelink (MIB-SL).

9. The method according to claim 1, wherein the second message is one or more of second synchronization information, a sidelink message, and sidelink control information (SCI) corresponding to the sidelink message, the second synchronization information is a synchronization signal and/or a master information block-sidelink (MIB-SL), and the sidelink message is a sidelink discovery message or a sidelink communication message.

10. The method according to claim 1, wherein the first message is sent by the second user equipment or third user equipment.

11. The method according to claim 1, wherein after the receiving, by first user equipment, of the first message, the method further comprises:
sending, by the first user equipment, a sidelink message to the second user equipment.

12. A signal processing apparatus, comprising first user equipment, and further comprising:
a receiver, configured to receive a first message;
a first processor, configured to determine, based on the first message, a first resource used by second user equipment to send a second message; and
a second processor, configured to process the second message by using the first resource, wherein the processing of the second processor comprises at least one of detecting and receiving.

13. The apparatus according to claim 12, wherein the first processor is configured to:
determine, based on a second resource used for the first message, the first resource used by the second user equipment to send the second message.

14. The apparatus according to claim 12, wherein the first message comprises indication information, the indication information is used to determine the first resource used by the second user equipment to send the second message, and the first processor is configured to:
determine the first resource based on the indication information.

15. The apparatus according to claim 13, wherein when determining, based on the second resource used for the first message, the first resource used by the second user equipment to send the second message, the first processor is configured to:
determine, based on a third message sent by the first user equipment and the second resource used for the first message, the first resource used by the second user equipment to send the second message.

16. The apparatus according to claim 14, wherein when determining the first resource based on the indication information, the first processor is configured to:
determine, based on a third message sent by the first user equipment and the indication information, the first resource used by the second user equipment to send the second message.

17. The apparatus according to claim 15, wherein the third message is a sidelink message and/or sidelink control information (SCI) corresponding to the sidelink message, and the sidelink message is a sidelink discovery message or a sidelink communication message.

18. The apparatus according to claim 12, wherein the second resource is one or more of a subband, a physical resource block (PRB), a subframe, and a resource pool, and the first resource corresponds to the second resource and is one or more of a subband, a PRB, a subframe, and a resource pool.

19. The apparatus according to claim 12, wherein the first message is a sidelink discovery message or first synchronization information, and the first synchronization information is a synchronization signal and/or a master information block-sidelink (MIB-SL).

20. The apparatus according to claim 12, wherein the second message is one or more of second synchronization information, a sidelink message, and sidelink control information (SCI) corresponding to the sidelink message, the second synchronization information is a synchronization signal and/or a master information block-sidelink (MIB-SL), and the sidelink message is a sidelink discovery message or a sidelink communication message;
wherein the first message is sent by the second user equipment or third user equipment;
wherein the signal processing apparatus further comprises:
a transceiver, configured to send a sidelink message to the second user equipment after the receiving module receives the first message.

21-25. (canceled)
